(19) United States
(12) Patent Application Publication
(10) Pub. No.: US 2019/0137743 A1
(43) Pub. Date: May 9, 2019

(54) METHOD FOR DIGITALLY COLLECTING A SAMPLE BY A MICROSCOPE

(71) Applicant: Sensovation AG, Radolfzell (DE)

(72) Inventor: Eik Schumann, Radolfzell (DE)

(73) Assignee: Sensovation AG, Radolfzell (DE)

(21) Appl. No.: 16/304,292

(22) PCT Filed: Jun. 12, 2017
(86) PCT No.: PCT/DE2017/100493

§ 371 Date: Nov. 25, 2018

(30) Foreign Application Priority Data
Jun. 15, 2016 (DE) 10 2016 110 988.6

(51) Int. Cl. G02B 21/00; G02B 21/36

(52) U.S. Cl. CPC G02B 21/0044; G02B 21/368; H04N 5/347; G02B 21/0072; G02B 21/367

(57) ABSTRACT

The invention relates to a method for digitally collecting a sample by a microscope. In order to obtain a rapid analysis of the sample by a physician, it is advantageous if the sample has been already collected in regions which have not yet been viewed by the physician. This can be achieved when a viewing section of the sample is selected, a microscope lens is moved in a scanning mode over this viewing section first in a sequence of offset images covering the viewing section. The image is digitally recorded and the represented, and subsequently the scanning route is continued with a sequence of images outside of the selected viewing section.

### CROSS REFERENCE TO RELATED APPLICATIONS

This US non-Provisional patent application is the 37 CFR 371 (US National Phase) filing of PCT/DE/2017/100493, filed Jun. 12, 2017 and based on priority application DE 102016110988.6, filed Jun. 15, 2016, and claims priority thereto. These prior applications are hereby incorporated by reference in their entireties.

### STATEMENT REGARDING FEDERALLY SPONSORED RESEARCH

Not applicable.

### STATEMENT REGARDING MICROFICHE APPENDIX

Not applicable.

### BACKGROUND

This invention relates to a method for imaging biological samples.

In pathology, biological samples are examined under a microscope by a physician in order to ascertain whether any anomalies can be found in the biological material. Here, the physician inspects the sample with a relatively small magnification by moving a viewing section of the microscope over the sample. Upon encountering a sample region of interest, the physician selects a larger magnification in order to examine this region in greater detail.

Both for reasons of documentation and global availability of a sample and in order to make a sample visible over a larger area and therefore more comfortably on a large screen, it is desirable to digitalise this inspection of the sample and to image the sample in high resolution, such that the sample can be displayed on a screen and it is possible to zoom in on regions of interest.

For rapid collection and display of a sample in various magnifications, microscopes having a plurality of microscope lenses of various magnification factors are used. Depending on the desired resolution or magnification, the suitable microscope lens is selected automatically, and an image of the sample in the desired viewing section in the desired magnification is collected and is displayed on a screen. Microscopes having an interchangeable lens of this kind, however, are relatively costly.

In order to be able to use a digital microscope having just a single lens, this must be equipped with a high magnification factor in order to enable even a heavily magnified collection of an image of the sample in the viewing section. If a lower resolution is desired by the physician, the sample must firstly be scanned by a large number of high-resolution collected images, such that it can be assembled image by image. The physician must wait until the scan is complete and an overall image assembled from the stored individual images can be referred to. In addition, the physician, each time he moves the viewing section, must wait until all individual images have been collected within the viewing window and the viewing window can be displayed fully on the screen. This makes the examination of a sample laborious.

### SUMMARY

The object of the present invention is to describe a method for digitally collecting images of a sample by microscope, with which method a rapid examination of the sample can be performed with the aid of a single microscope.

This object is achieved by a method of the kind described at the outset, in which in accordance with the invention a viewing section of the sample is selected, a microscope lens is moved in a scanning route over this viewing section, first a sequence of mutually offset images covering the section is digitally recorded and then displayed, and subsequently the scanning route is continued with a sequence of images outside the selected viewing section.

The invention is additionally directed to a digital microscope, in particular for carrying out the method according to the invention. The digital microscope expediently has a sample holder, microscope lens, a drive for moving the microscope lens over the sample, a camera for collecting images of the sample through the microscope lens, and a control unit for controlling the drive and for receiving images taken by the camera. The control unit is expediently also designed to display the collected images on a display means, for example a screen. The screen can likewise be part of the digital microscope.

In order to accelerate an imaging method, it is proposed that the control unit is designed in accordance with the invention to move the microscope lens in a scanning route over a viewing section, to digitally collect a sequence of mutually offset images covering the viewing section, and then continue the scanning routes with a sequence of images outside the selected viewing section. In the case of advance scanning, future moved viewing sections can be displayed rapidly.

Accordingly, as described in detail below, disclosed here is a method for digitally collecting an image of a sample by a microscope. The method may include selecting a viewing a section of the sample, moving a microscope lens in a scanning route over this viewing section, digitally collecting and displaying a first a sequence of mutually offset images covering the viewing section, and subsequently continuing the scanning route with a sequence of images outside the selected viewing section.

### BRIEF DESCRIPTION OF THE DRAWINGS

Various exemplary details are described with reference to the following figures, wherein:

FIG. 1 shows a digital microscope with a microscope lens and an overview lens over a sample in a sample holder,

FIG. 2 shows the sample from FIG. 1 in a plan view with a sample field with two tissue regions, two information fields next to the sample field, and a viewing section lying over one of the two tissue regions,

FIG. 3 shows the viewing section from FIG. 2 with scanning routes along which images of the sample are collected,

FIG. 4 shows the viewing section from FIG. 2 with a coloured outer region of lower resolution and an inner region of higher resolution by way of four images

FIG. 5 shows the sample field of the sample from FIG. 2 with a viewing section guided along a screening route in a meandering manner over the sample,

FIG. 6 shows the sample field with a viewing section guided over the sample in a tissue-dependent manner,

FIG. 7 shows a viewing section and an overview over a sample field in which images already collected are recorded, and

FIG. 8 shows a stack of images which were collected with focus positions varying in the z-direction and a scanning route started in a desired focal depth.

It should be understood that the drawings are not necessarily to scale, and that like numbers may refer to like features.

### DETAILED DESCRIPTION

The invention is based on the consideration that a physician—or more generally: a user—in some circumstances requires some time to examine the sample in the viewing section before he moves the viewing section. This time can be used to collect a picture of the sample, image by image, also outside the selected viewing section. If the user chooses another viewing section, this in some circumstances will have thus already been collected at least in part, and therefore the viewing section can be displayed on the screen without any time delay. The sample can hereby be examined relatively quickly, also using just one microscope lens.

In accordance with the invention a viewing section of the sample is selected. The viewing section can be a region within which one or more mutually offset images of the sample can be displayed to a user once the images have been collected. The viewing section is expediently smaller than the sample.

The sample can be a unit which is introduced into a sample holder of a digital microscope. The sample can have an examination region and a support region. The examination region is expediently the region intended for microscopic examination and in which for example biological material to be examined can be arranged. The examination region can be the region covered by a cover glass. The support region usually lies outside the sample region and can contain a code area, in which there is information relating to the sample, in particular machine-readable information, such as a sample reference, a sample type, an examination type, a sample origin, a tissue type and/or other information.

The viewing section lies expediently in the sample region. The viewing section can be selected automatically or manually. For automatic selection, the viewing section can be selected in an automated manner by a predefined algorithm on the basis for example of a sample area, a sample outline and/or sample shape, from which an individual region is selected as viewing section in accordance with the algorithm. The viewing section, in the case of automatic selection, is expediently selected depending on machine-readable information on the sample, for example a barcode on the support region of the sample. It is also possible to select the viewing section in an automated manner with use of abstract user information. Abstract user information in this case can be information that does not directly determine the viewing section, that is to say does not contain any coordinates or the like. The algorithm contains instructions that assign a viewing section to the abstract user information. The abstract user information is for example an examination method, wherein the position or appearance of the viewing section is directly predetermined depending on the examination method.

It is also possible to select the viewing section in an automated manner on the basis of a sample parameter. If the sample parameter defines a tissue type, such tissue can be localised by automated tissue identification. The viewing section can then form an individual region of the sample area in which the tissue lies.

In the case of manual selection of the viewing section by a user, it is advantageous if an overview of the sample region or of the entire sample is shown to the user on a display means. The sample region will also be referred to in a simplified manner hereinafter as a sample even if said term refers only to the area intended for the collection of images by a microscope lens.

In order to create the overview image, the sample can be recorded in one or more images. A number of images can be assembled to form the overview image. In order to achieve rapid creation of the overview image, it is advantageous if the overview image is collected by a first lens having a magnification of m≤1. m>1 is also possible, for example m=1.25. The user can now choose the viewing section from the displayed overview image, for example by specifying a position and in particular a size of the viewing section, for example by moving a mouse or touching a touchscreen.

Once the viewing section has been selected, a scanning route can be determined, which lies at least in part in the viewing section. The start of the scanning route advantageously lies in the viewing section. The scanning route is determined depending on the position of the viewing section in the sample. A lens is then moved in the scanning route over this viewing section, expediently once the scanning route has been determined, wherein the movement is a movement relative to the sample, regardless of whether it is the lens or the sample that is stationary element in absolute terms. The lens is expediently a microscope lens, that is to say a lens with m>1, in particular m≥5. The microscope lens expediently has a greater magnification than the first lens—if a first lens is provided.

The digital microscope for carrying out the method according to the invention expediently has just a single microscope lens, that is to say a magnifying lens with m>1. It is economical if the microscope lens has a pre-set and fixed magnification.

The images collected by the microscope lens can be displayed to the user, who can now view the sample in the viewing section with a higher resolution than would be possible by means of the overview image.

The scanning route can be continued outside the selected viewing section with a sequence of images, also without moving or changing the viewing section. Various approaches can now be followed with the collected images.

In the simplest approach the images are not shown to the user if the user is not moving the section over the continuation of the scanning route. Only when the viewing section is moved over the continued scanning route are the images of the continued scanning route now lying in the viewing window displayed.

In a more convenient variant the position of the collected images of the scanning route that lie outside the current viewing window is shown to the user. For example, the display means has a region in which the sample is shown as a whole or a smaller region of the sample, which is larger however than the viewing window, is shown, for example merely as a frame of the sample. Each collected image can now be displayed as a point or area in accordance with its position on the sample. The user can identify which region of the sample has already been imaged by the microscope lens. If the user has the choice, he can now move the viewing section deliberately into a region already containing collected images.

Another possibility lies in showing the newly collected images in the form of images, for example next to the display field of the viewing section. Each image is covered by the subsequent image, such that the images lying outside the viewing section are displayed only briefly. However, this can be sufficient to give the user the opportunity to identify images of interest. The user can then move the viewing section deliberately over images of this kind.

One or more images lying in the viewing section is/are displayed on a screen expediently such that it/they has/have a lower resolution than the image per se. The images are thus collected with a higher optical resolution than required by the viewer and/or displayed to the viewer on the screen. Of course, it is additionally possible to increase the detailing of the representation, i.e. to zoom in on the display of the sample, until the resolution of the display reaches the resolution of the image.

If the viewing section of the sample on the screen comprises a number of images, these are assembled to form an overall image which completely fills the viewing section. This assembled image can now be displayed wholly or partially to the user. The viewing section is expediently shown on a display unit. Hereinafter, by way of simplification, reference will be made to a screen, although this is not intended to limit the invention.

The display of the viewing section on the screen can be assembled from one or more images of the sample collected from the sample at the position of the viewing section. During the display, the viewing field of the microscope lens can move further over the sample in order to collect further images outside the viewing section, such that the viewing section at the time of the display does not have to match the field of view of the microscope lens towards the sample.

The display of the viewing section is therefore generally not a live display, and instead refers to one or more stored images. Nevertheless, the images can be displayed on a screen in real time, that is to say immediately after collection. Thus, there is no need to wait until the entire sample has been covered by images which are then displayed (in a manner assembled to form an overall image). If an image of the sample is thus collected in the viewing section, the display is expediently provided in real time, and consequently at the time at which an image is first displayed there is a live display of this image. This image, however, is held on the screen whilst the field of view of the microscope lens continues to move and creates the subsequent images. The previously collected image is then no longer a live display, and a permanent memory must be accessed in order to view said image.

The scanning route, that is to say the movement of the microscope lens over the sample and therefore the position of the sequence of images of the sample, is expediently defined by a stored algorithm and can be dependent on one or more parameters included by the algorithm. There are a large number of parameters that can influence the course of a scanning route over the sample, in particular sample parameters, image collection parameters and ambient parameters. Here, the sample parameters primarily determine the initial scanning route, i.e. the route first travelled by the microscope lens. The collection parameters and ambient parameters are relevant primarily in order to change a scanning route already traversed in part.

If the sample parameter is taken into consideration in the calculation of the initial scanning route, a collection of the sample that is efficient in respect of the intended examination can thus be achieved, such that a rapid examination of the sample is made possible. The above-mentioned object is achieved in this regard also by a method for digitally collecting images of a sample by a microscope, in which method in accordance with the invention a sample parameter is determined, a scanning route is determined as a function of the sample parameter, and a microscope lens is moved along the scanning route over the sample.

Sample parameters can be determined by the type of sample, that is to say an outer shaping of the sample, and arrangement of one or more sample regions on a sample support, for example as a micro array or as a slide, in large area and/or a thickness of the sample, by which the number of scan layers arranged one above the other in the z-direction is determined. Sample parameters can also be determined by a tissue type in the sample, by an examination method on the basis of which the sample is to be examined, by a patient ID or patient class from which the sample originates, on the basis of pathological information relating to the sample, a colour of the sample and/or a colour adjustment, which can be additive, i.e. coloured illumination, or subtractive in the form of a colour filter in an imaging beam path.

If one or more parameters changes/change during the course of the scanning process, this is advantageously processed by the algorithm immediately after the change, that is to say in real time, expediently in such a way that the scanning route is modified or recalculated depending on the change. This can occur already whilst the microscope lens is moving along the old scanning route. The old route can be terminated and the route can be continued with the new route.

By changing a route in response to a parameter change, examination of the sample can be significantly accelerated. In this regard, the above-mentioned object is also achieved by a method for digitally recording images of a sample by a microscope, in which method a scanning route for moving a microscope lens is determined and the microscope lens is moved along the scanning route over the sample. It is proposed that in accordance with the invention a parameter is changed already during the movement of the microscope lens along the scanning route over the sample, the scanning route is at least partially re-determined on the basis of this change and is hereby modified, the movement of the microscope lens along the old scanning route is terminated, and movement of the microscope lens is continued along the new scanning route. The scanning process can be directly adapted to user specifications, whereby rapid examination of the sample is possible.

Parameters which expediently lead to a change of an existing scanning route are for example image collection parameters. If an image collection parameter changes, the scanning route is expediently terminated and converted into a new scanning route. An image collection parameter can be changed by a user input. The collection parameter can change due to a movement of the viewing section over the sample, a change to the detailing of the display of the sample on the screen, that is to say a change to the zoom level when viewing the sample, a change to the focus depth in the sample, a change to the colour by means of filters or lighting and/or a change to the exposure time of the individual images.

It is likewise expedient if user inaction leads to a change to an existing scanning route. If there is no user input over a predefined period of time, the scanning route may thus likewise be changed, for example guided in longer straight lines without a change in direction, so as to reduce scanning noise. The scanning can be slowed, with the same advantage.

A change to the scanning route could be advantageous also in the event of a change to an ambient parameter. For example, if the digital microscope experiences acceleration above a limit value, for example by a person bumping into a table on which the digital microscope is set up, it can be that the images collected during the acceleration are defective. The scan can thus be interrupted, and the images in question collected again, if the acceleration has dropped back below the limit value. For this purpose, the digital microscope expediently comprises an acceleration sensor, which is connected, for signal exchange, to the control unit for controlling the scanning process.

A change in temperature above a limit value, in particular a limit value per unit of time, can also be critical for high-quality images, since the focus in the sample can move as a result of material expansions. It is accordingly advantageous if the scanning route is changed in the event of a temperature change above a limit value, for example a new autofocus process is performed and the scanning route is then arranged in a new autofocus plane. The temperature can be a temperature at or around the microscope lens or another component within or on the digital microscope.

What is likewise relevant for the scanning route is a collection result of one or more images. For this purpose, a contrast analysis can be performed during the scan. If the contrast delivers a sufficient index that the focusing is too imprecise, an autofocus process can be performed, and the scanning route can be arranged in a new autofocus plane depending on the result. For this purpose, for example a test image is firstly collected in a scanning plane different from the current scanning plane, and the contrast of the test image is evaluated. Depending on the results, a new test image is collected or the scanning route is arranged in a plane in which the test image lies.

Generally, it can be advantageous if, during the scanning process, i.e. as the current scanning route is travelled, an autofocus process is performed. For this purpose, x- and y-coordinates of one or more autofocus points can be defined, which the microscope lens then approaches during the scan. An autofocus is then performed there. Depending on the result, the autofocus plane is determined, that is to say the plane in which the focus during the scan lies as a result of the autofocus process. It is also advantageous to design the scanning route either initially or subsequently such that the autofocus points are quickly approached, such that the calculation of the autofocus plane can start as early as possible.

A collection parameter influencing the scanning route is for example the position of the viewing section on the sample. If the viewing section covers the sample only in part, that is to say goes beyond the edge of the sample, the scanning route is expediently limited only to the region of overlap of the viewing section with the sample. The area of the sample is expediently the area of a microscopy region, that is to say for example the region that can contain tissue. A sample support, such as a glass slide, on which the sample is contained can extend therebeyond.

If a viewing section has been selected by a user, the collected images thus cover the viewing section in part or completely. Depending on the size of the selected viewing section, it can be completely covered already by a single image. Generally, however, it is only covered in part by an image, such that the entire viewing section is assembled from a number of adjacently arranged images. The images are mutually offset and can overlap one another in part in order to facilitate a stitching of the images to form a larger overall image, that is to say an automated assembly on the basis of an image content comparison of adjacent images in their region of overlap. The images can also be offset in the vertical direction, i.e. z-direction, for example if a number of images are arranged in different focus planes or one above the other, that is to say mutually offset in the z-direction.

The images are created in that the field of view of the microscope lens is moved relative to the sample, and the sample is imaged in the positions of the field of view shifted by the movement. Depending on the exposure time, the microscope lens can rest at the time of collection or, in particular in the case of very short exposure times, can be moved continuously, without any interfering blurring occurring in the images. The movement of the microscope lens relative to the sample and thus also the selection of the position of the images is controlled by the algorithm expediently depending on the size of the selected viewing section in the sample.

The viewing section is shown on the screen, such that the sample in this way can be viewed by a user of the digital microscope. The images lying outside the viewing section expediently are not displayed at this time, not until the viewing section is moved into these images already collected. If the viewing section is moved into a region of the sample that has not yet been collected wholly or partially, the part of the region of this viewing section not yet collected is collected directly subsequently to the displacement or already during the displacement. The course of the scanning route is dependent in this regard on the movement of the viewing section.

At the start of the method a user can define the viewing section, for example on the basis of a previously collected overview image of the sample, or the viewing section is defined by an algorithm, for example depending on the type of sample.

In an advantageous embodiment of the invention an overview image of the sample is firstly created, in which the entire sample region or the entire sample field of the sample is shown. On the basis of this overview image, the user can choose the viewing section that he would like to look at first. This is implemented for example in that the user marks the region of interest in the overview image of the sample using a marking means, for example a mouse. The marking can be made by creating a window or by marking a point in the overview image of the sample. The viewing section can now be placed in or around the marking, for example in the size of the marked window or in a pre-set size, in particular symmetrically, around a marked point.

The size of the viewing section can be selected expediently by the user, for example by determining a geometric size, for example by marking a region of the sample on a screen, or by defining a detailing or simulated optical magnification. When choosing the region or size thereof, the size of the viewing section on the screen can be dependent on the selected magnification.

The size of the viewing section is expediently greater the size of a single image predefined by the microscope lens, such that the viewing section is covered by a plurality of images. The scanning route is now selected such that the viewing section is scanned and assembled image by image.

The time taken by the user, starting from an overview image, to find a region of interest and to select this by a marking can be used advantageously in that a scanning route is already initially defined and travelled through image by image, before the viewing section is selected. It is hereby possible that the viewing section selected later can already be displayed partially or fully on the display means, already without the creation of new images, such that the display of this viewing section is accelerated.

The scanning route is advantageously defined in the selected viewing section such that it is guided outwardly from the centre of the viewing section, in particular in a spiralled manner. The first image therefore covers the centre of the viewing section, and the subsequent images are arranged around the first image. The viewing window of interest to the user is filled from the inside out with image-related content. A mostly quieter and quicker variant is a meandering scanning route, which in particular lends itself in the case of a quick image sequence, that is to say for example in the case of short exposure times. A scanning route depending on a movement of the viewing window is likewise advantageous. If the viewing window has been moved in a direction, the filling of the new viewing window in this direction is the most ergonomic. If the viewing window for example has been moved to the right, the scanning route could thus fill the viewing window perpendicularly in a meandering manner to the right.

It is also advantageous if the scanning route is continued in a manner expanding outwardly outside the viewing section in a spiralled manner around the viewing section. If the viewing section is moved, images already collected fall into the moved viewing section, such that this can be displayed quickly.

Here as well, however, other patterns can also be advantageous, for example depending on a sample parameter or a position of tissue in the sample. Individual images or a scanning route interrupted a number of times, that is to say images distanced from one another or route parts not arranged contiguously, are also advantageous. For example, the sample is scanned with a number of individual images, that is to say with images or route parts that are in each case surrounded fully by an image-free region. A larger area can hereby be scanned randomly, for example in order to find tissue. If tissue has been found in an image, further images can now be attached to this “successful” image in order to further image the tissue region. If priority regions have already been identified, for example from an overview image, the scanning route can jump from one priority region to the next. A priority region can be a region comprising tissue or another substance that is to be examined.

If images already stored in part are present in a moved viewing section, those regions of the viewing section not yet imaged are collected by the microscope lens advantageously first, and in particular exclusively. The scanning route moves in each case for example in the direction from the middle of the viewing section to the edge of the viewing section.

In the case of a scanning route within the viewing section it is advantageous if, in the case of an as yet—partially—unscanned viewing section, the route is optimised for the quickest possible scanning of the entire viewing section. By contrast, in the case of a scanning route outside the viewing section, it is advantageous to increase the scanning rate, i.e. to achieve a greater number of images per unit of time, than was the case with the scanning route within the viewing section. This is achieved generally by long straight scanning lines. Generally speaking, the course of the scanning route can be a compromise between quick scanning of a region, for example around the current viewing section, and a high scanning rate.

When a sample is examined by a user, it can be that the user changes a parameter. An example of a parameter change of this kind is a change to the magnification factor. With the presence of an overview image, the selected viewing section will lie in the region of the image of the overview image, wherein a higher magnification is assigned to the viewing section than the overview image. The sample can now be shown in the region of the viewing section with the resolution of the overview image, however this is not the resolution desired by the user, and therefore the overview image is not a current image.

Another parameter change is provided when the focal plane is changed. The various image planes now lie one below the other or one above the other in the z-direction.

Yet another parameter change is present when a spectral region of the images is changed, for example in the case of fluorescence microscopy. One image plane then has a spectral region of the images different from another image plane.

Likewise possible is a parameter change in such a way that an exposure time or colour channel selection of the images has been changed. If, for example in order to save time, a sequence of images was recorded with a low exposure time, for example with use of digital image lightening, and if an image is now to be collected in the same physical position with a higher exposure time, this also constitutes a parameter change, since the previously collected image is not current in respect of its image quality.

A change to the scanning route will be described hereinafter as an image plane change, in which the images of the older, non-current scanning route lie in a different image plane as compared to the new images of the current scanning route. Here, an image plane can be referred to as a location or a region in a multi-dimensional parameter space, in which each parameter assumes a dimension. If a parameter, or more precisely parameter value, changes, the image plane moves in the parameter space.

Depending on the type of parameter change, the scanning route can be guided inside or outside the viewing section in a manner dependent or independent of images already collected of a non-current image plane. If, for example, the focus depth in the sample is changed, it can be expedient to replace blurred non-current images by new sharp images. The new image plane can then be recorded separately and independently of other image planes. Here, however, images of another image plane can also be shown, such that current images and non-current images of the viewing section are displayed side-by-side. The user can hereby orient himself more quickly to the sample or within his viewing section.

In this regard, it is advantageous for the display of the sample in the viewing section if reference is first made to one or more images or collections thereof unsuitable for the current microscope settings. The unsuitable or non-current images can now be covered image by image by the current sequence.

The non-current collected images can constitute in this regard a total image or an overview image of the sample, or part thereof. It is likewise possible that the non-current collected images have been collected in a spectral range other than that used for the sequence of the current images, for example due to a spectral filter or another collection mode, such as bright field imaging compared to fluorescence imaging. A further possibility lies in the fact that the non-current collected images might have been collected using a different focus position in the sample.

In order to make it easier for the user to gain an overview of which of the images are current and which are non-current, it is advantageous if the display of the non-current collection of images is different from the display of the current image, in such a way that it is possible to distinguish between the non-current images and the current image. This can be achieved by means of a colouring of the old regions, a concealment, or another labelling.

In the event that the viewing section is moved, so as to be able to show the largest possible region of the new viewing section without collecting new images, it is advantageous if the scanning route, before the viewing section is actually moved, is defined such that it runs into the viewing section to be moved later. In order to achieve this, an algorithm can calculate a probability with which a collection parameter will be changed next, in particular during the current scan. For example, a calculation is made as to where the viewing section will be moved to within a defined time window within the region of the sample calculated accordingly on the basis of the probability.

Another possibility lies in defining the scanning route on the basis of boundary conditions, which are predefined. For example, it is advantageous if information regarding the type of sample is obtained from an image of the sample and the scanning route is selected outside the selected viewing section depending on the sample type. The user or physician can be faced with different problems with regard to the analysis of the sample depending on the sample type, on which basis a movement of the viewing section can be predicted with sufficient probability.

Information for example regarding the type of sample can be obtained from a labelling on the sample, expediently a machine-readable code, for example a barcode. A further possibility for identifying the type of sample lies in identifying the tissue in an image of the sample.

More meaningful regions of the sample can be distinguished from less meaningful regions, for example regions comprising more tissue can be distinguished from regions comprising less or no tissue, by means of image recognition. In this way, regions can be classified into higher-classified regions and lower-classified regions. Regions of greater or lesser interest, i.e. higher-classified or lower-classified regions, can also be defined on the basis of the type of tissue. In order to predict a scanning route outside the viewing section, tissue identification can therefore be performed on the basis of an image of the sample, for example an earlier image, a non-current image and/or an overview image of the sample. The scanning route is now controlled expediently outside the viewing section depending on results of the tissue identification.

The scanning route advantageously firstly passes through regions of higher classification and then regions of lower classification, for example firstly regions comprising identified tissue and then tissue-free regions.

Analysis rules on the basis of which a user should perform a scan of a sample can be affiliated with certain tissue types. A typical example is a screening in which the physician views the entire sample along a screening route, which for example is a meandering route. A screening route of this kind can be scanned in advance in that regions of this kind of the screening route are covered with images in which the viewing section is not yet located. Generally speaking, it is advantageous if the scanning route runs along a predefined screening route of the viewing section, wherein in particular the images are created outside the viewing section before the viewing section moving along the screening route detects or covers these regions.

More generally speaking it is advantageous if a calculation is performed with regard to where the viewing section will next move to, and the scanning route is guided outside the viewing section depending on the calculation result. With a calculation of this kind, an earlier movement of the viewing section by a user is taken into consideration. The type of sample is expediently also or alternatively included in the calculation. The sample type can be input by a user or can be optically determined by a control unit of the digital microscope.

The prediction of a future position of the viewing section can also be improved in that a character of the sample in the current viewing section is determined and regions of the sample of similar character are traversed by the scanning route before dissimilar regions. In this regard the character of the sample in the current viewing section can be included in a calculation of where the viewing section will move to next, wherein the calculation also includes character similarities of regions of the sample from other regions of the sample in the calculation.

This method can be combined with the method of tissue identification. In the tissue identification the sample is searched for predefined tissues or image contents, such that regions of identified tissue can be distinguished from tissue-free regions. It is even more precise if different tissue types or image content types are distinguished and preferably a specific tissue type is approached. Without loss of generality, reference will be made hereinafter to tissue type and is intended to comprise generally a type of sample or structures/image contents.

Instead of obtaining the tissue type or a type of sample from a general tissue identification or from a tissue-free region, such as a barcode or the like, the tissue type can be defined by the selection of the position of the viewing section in the sample. A tissue type in the viewing section can be determined, and this tissue type can preferably determine scanning regions insofar as these contain a tissue type of this kind, optionally with a predefined edge region around the discovered tissue type regions.

If a viewing section is selected in an automated manner by a user or by a control unit of the digital microscope that is much greater than an individual image of the microscope lens, that is to say the magnification thereof is much lower than the magnification of the microscope lens, the scanning of the viewing section can take a relatively long time, in particular if it is moved again and again. In order to reduce the collection time of the individual images it is advantageous if pixel binning of a detector collecting the images is performed depending on the size of the viewing section, i.e. a number of pixels are combined to form a common pixel for signal amplification. In this way the exposure can be reduced, and the images can be collected more quickly in succession. The images in this case have a reduced resolution, however this can be tolerated in the case of a viewing section with a low magnification.

Pixel binning is expediently performed automatically, in particular depending on a ratio of the resolution of the display of the viewing section on a display means (zoom level) to the resolution of the collected images. For example if the ratio is below a limit value, the pixel binning can be performed automatically. Pixel binning is advantageous in particular with a long exposure time, as is the case with fluorescence imaging. However, pixel binning is also advantageous in the case of high user activity, for example if the user moves the viewing section quickly in succession. If, however, the viewing section remains for a long time at each of a number of locations, the binning can possibly be dispensed with in order to achieve a better imaging quality.

Generally, the pixel binning can be performed automatically depending on the zoom level, imaging channel and/or user activity. Pixel binning shall be understood generally to mean also the selective reading of just part of the overall detector elements, even without the combining of detector elements.

As already mentioned, a reduction of the exposure time without pixel binning can also be considered in order to increase an imaging speed. By means of a subsequent image processing, for example a magnification of the contrast and/or an image lightening, the otherwise dark images can be made suitable for evaluation. In this regard it is advantageous if an exposure time of the images is selected depending on the size of the viewing section.

If fluorescence images of the sample are created, a spectral channel selection of the images depending on the size of the viewing section can increase the imaging speed. For example, images are collected in just one spectral channel in order to give the user an overview initially of the inspected region of the sample.

Before a microscope image of the sample is created, it is advantageous if a suitable focus position of the microscope image is determined. For this purpose, an autofocus method can be performed, with which a suitable autofocus position of the microscope lens for creating the images is defined. An autofocus depth or autofocus position of this kind is expediently defined at a number of locations of the sample, such that an autofocus plane can be arranged through these points. The scanning route runs expediently at least initially in the autofocus plane. The focal depth can be understood to be a depth in the z-direction, that is to say perpendicularly to the sample plane, in which the focus of the microscope lens lies. The sample is now imaged sharply in the focal depth. Autofocus depth can be a focal depth in which the focus has been adjusted by an autofocus method. An autofocus depth lies expediently in a material region of the sample that is to be examined. A plurality of different autofocus depths in the x- and/or y-direction can form an autofocus plane, which expediently lies parallel to the sample plane.

In the case of very reliable autofocus methods as well, it can be that, at a high magnification selected by the user, the user nevertheless still adjusts the focus position manually in order to obtain an image of the sample that to him is optimal. In order to enable manual focusing as rapidly as possible, the scanning route runs expediently in the depth direction firstly around an autofocus depth. This is expedient in particular when the user chooses a zoom factor or a magnification of the viewing section above a limit value, for example above 10×. If the scanning route, after a change to the focus position of the microscope lens by the user, is guided firstly in the z-direction, a stack of images is then provided very rapidly in the z-direction, on the basis of which the user can set a focus position that is optimal to him.

Once the focal depth has been set, in particular following a manual setting of the focus depth, it is advantageous if the scanning route runs in the plane of the set focal depth. It is to be assumed in respect of a setting of the focal depth that the user will inspect the sample at this focal depth, such that an advance scanning of this focal plane can accelerate the examination. Here, it is advantageous if the scanning route is parallel to an autofocus plane determined in an autofocus method.

Once the imaging stack has been created in the z-direction, the scanning route can run horizontally again, for example in the current focal plane of the microscope lens.

The invention is additionally directed to a digital microscope, in particular for carrying out the method according to the invention. The digital microscope expediently has a sample holder, microscope lens, a drive for moving the microscope lens over the sample, a camera for collecting images of the sample through the microscope lens, and a control unit for controlling the drive and for receiving images taken by the camera. The control unit is expediently also designed to display the collected images on a display means, for example a screen. The screen can likewise be part of the digital microscope.

In order to accelerate an imaging method, it is proposed that the control unit is designed in accordance with the invention to move the microscope lens in a scanning route over a viewing section, to digitally collect a sequence of mutually offset images covering the viewing section, and then continue the scanning routes with a sequence of images outside the selected viewing section. In the case of advance scanning, future moved viewing sections can be displayed rapidly.

Movement of the microscope lens over the sample is generally a relative movement, such that, in absolute terms, the microscope lens is moved over the sample or the sample is moved below the microscope lens, which in absolute terms is stationary.

The previously given description of advantageous embodiments of the invention contains numerous features which are reproduced in various combinations with one another in some of the dependent claims. These features, however, expediently can also be considered individually and can be combined to form meaningful further combinations, in particular in the case of dependency references of claims, such that an individual feature of a dependent claim can be combined with one or more features of another dependent claim. In addition, these features in each case can be combined individually and in any suitable combination both with the method according to the invention and with the device according to the invention in accordance with the independent claims. Method features shall thus be considered to have been drafted representationally also as properties of the corresponding device unit, and functional device features shall also be considered as corresponding method features.

The above-mentioned independent embodiments of the invention, the calculation of the scanning route on the basis of parameters, the change to the current scanning route depending on one or more parameter changes, and the further scanning outside the current viewing section can be combined with one another arbitrarily. In addition, details relating to one of the embodiments—regardless of its description in any of the dependent claims—can be combined with one or both of the other embodiments.

The above-described properties, features and advantages of this invention, and the way in which these are achieved will become clear and comprehensible in conjunction with the following description of the exemplary embodiments explained in greater detail in conjunction with the drawings. The exemplary embodiments serve to explain the invention and do not limit the invention to the combination of features specified therein, not in respect of functional features either. In addition, features of any exemplary embodiment suitable for this purpose can also be considered explicitly in isolation, removed from an exemplary embodiment, introduced into another exemplary embodiment for supplementation thereof and/or combined with any of the claims.

In the following description, the reference numbers refer to the features as follows:
2 digital microscope
4 sample holder
6 sample
8 sample support
10 cover glass
12 drive
14 housing
16 microscope
18 microscope lens
20 matrix detector
22 camera
24 lens support
26 drive
32 detector
34 overview lens
36 screen
38 input unit
40 information field
42 information field
44 viewing section
46 z-direction
48 sample field
50 scanning route
52 image
54 screening route
56 tissue region
58 spectral filter
60 beam path
62 acceleration sensor

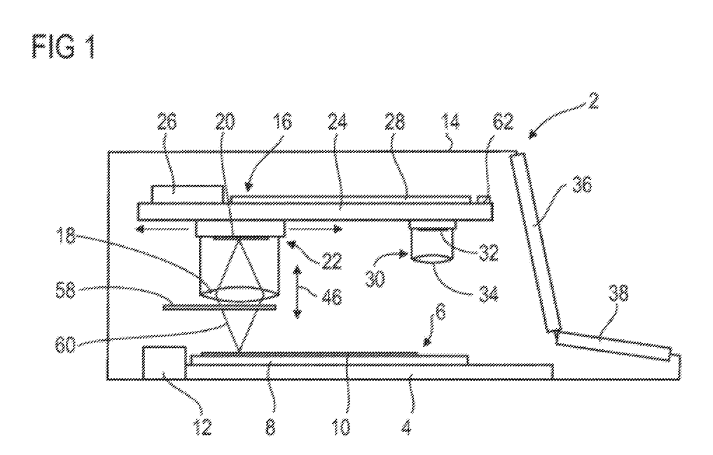

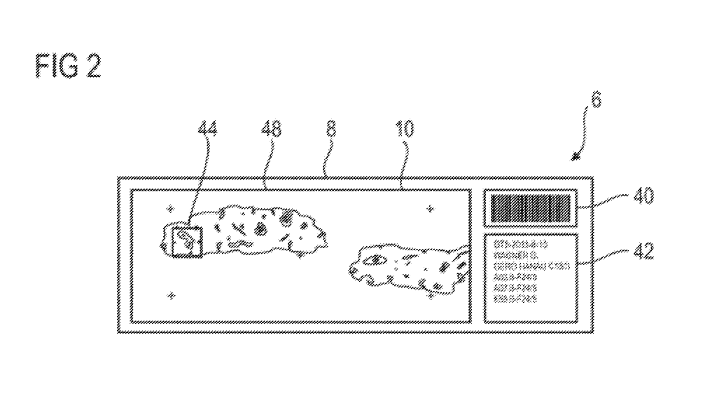

FIG. 1 shows a digital microscope 2 with a sample holder 4, in which a sample 6 has been placed. The sample 6 has a sample support 8 and a cover glass 10 and biological material arranged between the sample support 8 and cover glass 10, as indicated in FIG. 2 in the plan view of the sample 6. The cover glass covers the sample region completely, that is to say the region of the sample in which material to be examined can be arranged. The sample region is also referred to hereinafter as the sample field 48. A support region, that is to say the region of the entire sample around the sample region, is arranged in a ring around the sample region. Two information fields 40, 42 are arranged in the support region and contain the sample information.

The sample holder 4 can be moved within a housing 14 of the digital microscope 2 with the aid of a drive 12, such that the sample 6 can be placed into the sample holder from outside the housing 14, and the sample holder 4 is moved by means of the drive 12 into the housing 14 and beneath the microscope 16.

The microscope 16 comprises a microscope lens 18, which is illustrated merely schematically in FIG. 1 and by means of which the sample 6 is imaged on a matrix detector 20 of a camera 22. The microscope lens 18 is secured to a lens carrier 24 and can be moved two-dimensionally with the aid of a drive 26, as is indicated by the two arrows in FIG. 1. The collection of an image through the microscope lens 18 is controlled by a control unit 28, which also controls the drive 26 in order to move the microscope lens 18 over the sample 6. Alternatively, the sample 6 can be moved beneath the fixed microscope lens 18, such that it is possible to dispense with the drive 26.

The digital microscope 2 is also equipped with an overview camera 30, which comprises a detector 32 and an overview lens 34 for imaging the sample 6 on the detector 32. The overview camera 30 can likewise be secured to the lens carrier 24 and moved into a suitable position over the sample 6, such that an image of the sample 6 as a whole is collected by the overview camera 30. Alternatively, the overview camera 30 can be securely fixed relative to the housing 14 in such a position that it can receive the sample 6 completely when the sample 6 has been brought by the drive 12 into its examination position within the housing 14.

The images collected by the overview camera 30 and the microscope camera 22 are shown to a user on a screen 36. The user can enter inputs and commands via an input unit 38, for example a keyboard and a mouse, which inputs and commands are processed by the control unit 28, which for example controls the position of the microscope camera 22 accordingly.

FIG. 2 shows the sample 6 in a plan view from above. What can be seen are the sample support 8 and the cover glass 10 as well as two information fields 40 and 42, which for example are realised in the form of adhesive labels on the sample support 8. The information field 40 carries a machine-readable code, for example a barcode, which contains information relating to the sample 6, for example the type of sample. The information field 42 contains information in the ASCII format, i.e. with letters, numbers and symbols, on the basis of which the user can infer information relating to the sample 6 that is important to him.

The digital microscope 2 is suitable for bright and dark field analysis with incident light and transmitted light and also for fluorescence analysis of the sample 6 and to this end is equipped with corresponding lighting units, which have not been shown in FIG. 1 for the sake of clarity. Hereinafter, bright field examination methods will first be described, followed by fluorescence examination methods.

The sample 6 is firstly placed by a user into the sample holder 4, which is located outside the housing 14 of the digital microscope 2. The sample holder 4 is inserted into the housing 14 and moved into the examination position by means of the drive 12.

The user, on the basis of an input made on the input unit 38, can decide which method he wishes to use in order to examine the sample 6. An overview image of the entire sample 6 inclusive of the information fields 40, 42 can be collected optionally with the aid of the overview camera 30. The overview image is shown to the user on the screen 36. Also in the case of a fluorescence examination it is expedient that an overview image is collected in the bright field or dark field.

It is possible that the sample holder 4 can receive a number of samples 6 side-by-side or one below the other, such that a number of samples 6 can be examined in a single process step using the digital microscope 2. It is likewise possible that a sample 6 is divided into a number of sample regions arranged separately from one another, for example if the sample comprises a micro array with multiple small sample vessels.

The overview image can be an image over all samples 6 on the sample holder 4, or a separate overview image is created for each sample 6, these then being shown individually or jointly on the screen at 36. The user can then choose the order in which he wishes to examine the samples 6.

The user chooses a sample 6 for examination, for example the sample 6 shown in FIG. 2. On the basis of one or both information regions 40, 42, the control unit 28 for example determines a type of sample and an examination method, optionally patient data and/or pathological information. These sample parameters are used in order to calculate a scanning route.

On the basis of the overview image, which is shown in FIG. 2, the user chooses a region of interest by clicking on or marking this region using the input unit 38. A viewing section 44 is hereby produced. Depending on the examination mode, the viewing section 44 can also be predefined, that is to say automatically selected. Automatic selection is performed by an algorithm which is executed in the control unit 28 on the basis of data provided for this purpose, for example the predefined examination mode, which for example is indicated explicitly or implicitly on an information field 40, 42. Generally, the viewing section 44 can be selected within the scope of an automatic selection depending on machine-readable information and an information field 40, 42.

It is also possible to select the viewing region in an automated manner on the basis of a sample parameter. This can be indicated on an information field 40, 42, or can be input by a user, for example by a user input indicating the type of sample 6, the patient from whom tissue on the sample 6 originates, or the practice or laboratory from which the sample 6 has come. If the sample parameter defines a tissue type, such tissue can be located by automated tissue identification, for example by means of an overview image. The viewing region 44 can then form an individual region of the sample area in which the tissue is arranged. The algorithm contains instructions assigning a viewing region 44 on the basis of abstract user information of this kind.

General selection data on the basis of which the viewing section 44 is automatically selected can be the sample area, the sample outline and/or a sample shape, that is to say the area, the outline and/or the shape of the sample field 48. For example, the initial viewing section 44 always lies in the upper left-hand corner of the sample field 48 or in the middle thereof.

The viewing section 44 is displayed on the screen 36 in magnified form. Depending on the magnification of the viewing section 44, the viewing section 44 is displayed with image data of the overview image or with images that were collected by the microscope lens 18.

Before the images are collected by the microscope lens 18, it is expedient to set a suitable focus position of the microscope lens 18 in the sample 6. This can be achieved for example with the aid of an autofocus method. In the case of the digital microscope 2 shown, the autofocus method is performed autonomously, for example once the overview image has been collected and shown to the user on the screen 36. For this purpose, the microscope lens 18 travels over the sample 6 and in the z-direction 46, that is to say in the depth direction of the sample 6 and perpendicularly to the sample plane of the sample 6. The distance of the biological material from the microscope lens 18 and a focus position of the microscope 16 in the biological material are determined for example on the basis of the brightness profile of incident light reflection at the sample support 8 and the cover glass 10.

This focus position is marked expediently in the middle of the sample field 48, as is indicated by a small cross in the middle of the sample field 48 in FIG. 2. The microscope lens 18 is now moved in the x- and y-direction and the suitable autofocus position is measured at a number of other points of the sample field 48, as is indicated by the four outer crosses in the sample field 48 from FIG. 2. An autofocus plane that lies in the biological material is calculated from the plurality of autofocus positions. The autofocus plane is used as a starting plane for the first images of the sample material.

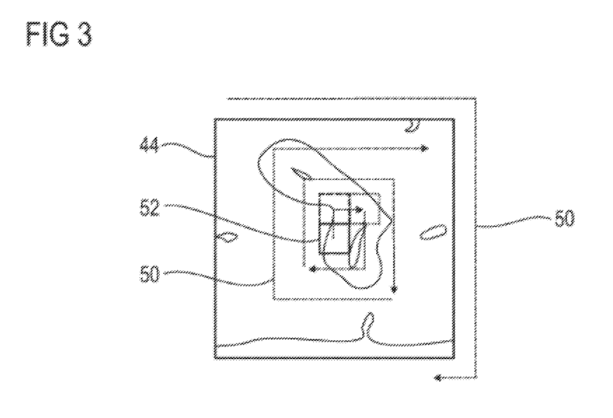

Once the viewing section 44 has been defined, a scanning route (FIG. 3) is calculated by the control unit 28. The selected viewing section 44 of the sample 6 is additionally also shown on the screen 36. The magnification of the viewing section 44 can be predetermined, or the user, with the selection of the viewing section 44, also defines the size of the viewing section or the optical magnification with which he wishes to view the sample 6 through the viewing section 44.

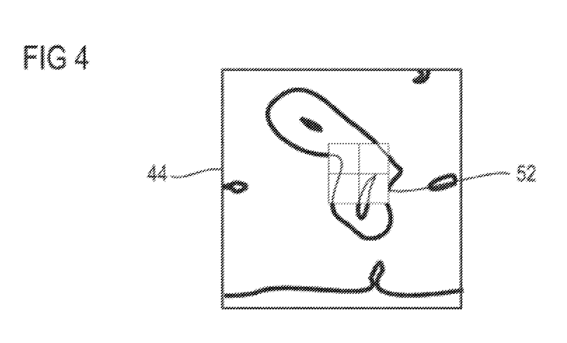

Depending on the resolution of the overview image, it can be that the resolution of the overview image is sufficient to show the sample 6 in the pre-set or selected viewing section 44 on the screen 36. Regardless of this, the microscope lens 18 starts to move along the calculated scanning route 50 over the sample 6 and to collect images 52 of the sample 6. If the resolution of the overview image is sufficient, it is possible to dispense with the display of the images 52. If the resolution is insufficient, the images 52 are shown on the screen 36. An optional case differentiation is shown in FIGS. 3 and 4.

FIG. 3 shows the viewing section 44 shown on the screen 36. The image content originates from a previously collected image of the sample 6, for example an overview image, and generally does not match the current position of the microscope lens 18 over the sample 6. In order to display the sample 6 and the viewing section 44, reference can be made for example to the overview image, which, depending on the resolution of the sample 6, shows a sharp image, as shown in FIG. 3, or a blurred image, as is indicated by the thick lines in the outer regions of the viewing section 44 in FIG. 4.

Even if the resolution of the old or non-current image, for example the overview image, is sufficient, the control unit 28 controls the microscope lens 18 in a scanning route 50 over the sample and controls the collection of a sequence of images 52 by the microscope lens 18. The images 52 in this sequence are mutually offset within the viewing section 44, such that the sample 6 within the viewing section 44 is collected image 52 by image 52 in the resolution and/or magnification of the microscope lens 18.

Here, the scanning route 50 starts in the middle of the viewing section 44. The first image in this regard covers the centre point of the viewing section 44 symmetrically or asymmetrically. The scanning route 50, which is shown in FIG. 3 by dot-and-dash lines or arrows, runs outwardly in a spiralled manner starting from the middle in the direction of the edge of the viewing section 44. The microscope lens 18 travels over the sample 6 along the scanning route 50 and captures a sample image 52 by image 52, as shown in FIG. 3.

In FIG. 3 the first image 52 is shown by solid lines, the second image 52 is shown by dashed lines, and the third image 52 is shown by dotted lines. Further images are not shown for the sake of clarity. However, it can be seen that over the course of time the entire viewing section 44 is covered by images 52 in the order of the scanning route 50, and therefore highly resolved image data of the sample is available in the entire viewing section 44.

If, as is indicated in FIG. 4 by the thick lines, the old image of the sample 6 is blurred since its resolution is insufficient to show the desired pre-set magnification on the screen 36, and the same approach as above is adopted in principle. Here as well the microscope lens 18 moves along the identical scanning route over the sample 6, image 52 by image 52. The old image area of the viewing section 44 here shows blurred image details, whereas the portions of the images 52 of the viewing section 44 are shown in focus because they are produced from the image data of the images 52. Accordingly, the sharp image region becomes larger from the inside out, as indicated in FIG. 4. In order to allow the user to distinguish more easily between current and non-current image portions, the non-current image portions are coloured, for example using a grey shade. This is advantageous in particular if the resolution of the non-current image regions is still quite good, and therefore the image quality differences between the current and non-current image portions are not immediately evident.

After a certain amount of time, the entire viewing section 44 is covered with images 52, and therefore the image display within the entire viewing section 44 can be fed with current images 52 or sharp image data. In principle, the scan can then be stopped and a break can be taken until the viewing section 44 is moved by the user to another region of the sample 6. This viewing section 44 would then also be scanned image 52 by image 52, such that the image of the viewing section 44 is assembled piece by piece in the current display. However, since this takes up a certain amount of the user's time for each moving viewing section 44, it is advantageous if the current image data of a moved viewing section is also already present at the time of the movement. Advance scanning is necessary for this purpose, also outside the viewing section 44.

Advance scanning of this kind is indicated in FIG. 3. As soon as the entire viewing section has been covered by current images 52, the scan or the scanning route 50 is continued outside the viewing section 44, as indicated in FIG. 3 by the outermost dot-and-dash arrow.

One possibility lies in that the scanning route 50 runs outside the viewing section in a spiralled manner around the viewing section 44 and widens radially, spiral path section by spiral path section, until the limits of a region of interest or of the sample field 48 are reached. If a limit of this kind is reached, the scanning route 50 reverses and travels over the next outer series of images in a reverse spiral shape. If the viewing section 44 is now moved slightly by the user, current image data can be referred to, and the viewing section 44 can be shown currently.

If the viewing section 44 has been moved and passes over images 52 already collected, these images are shown directly in the new viewing section 44. If the new viewing section 44 is only partially occupied by available images 52 and part of the viewing section 44 is not yet occupied by images 52, the continuation of the new scanning route is dependent on which part of the viewing section 44 is already available with images and which is not. If only an edge portion of the viewing section 44 has already been imaged, the scanning route 50 continues in the middle of the viewing section 44, such that said viewing section is filled from the centre outwards. If the centre has already been covered, the new scanning route 50 adjoins the available images 52 from the inside out in a meandering manner. This is also true if the middle has not been covered, but the available images 52 reach the middle up to a predefined distance, for example to less than 20% of a viewing section edge length.

If all images 52 of the new viewing section 44 have already been collected after the movement, it is possible to do without any change to the scanning route, such that said scanning route outside the viewing section 44 is not changed.

A current display does not necessarily mean that a current view of the sample 6 is shown. Reference is always made to stored images 52, even if the sample 6 for example is moved or removed from the digital microscope 2. In this context, the term “current” is to be understood insofar as the images 52 have been created in the way set by the user (or in accordance with the pre-setting of the control unit 28).

The user can change multiple parameters, such that the display of the viewing section 44 on the screen is changed. If the user changes a parameter, this is recorded by the control unit 28 and included in the calculation of the scanning route 50. The scanning route 50 is generally influenced and changed hereby. As a result, the traversing of the current scanning route 50 is stopped, and the microscope lens 18 is now moved along the re-calculated scanning route 50 and collects new images 52.

If a parameter is changed, for example a collection parameter, the image plane changes and the previously collected images 52 are non-current. The parameters can comprise the resolution or magnification, the focus depth, exposure, pixel binning of the matrix detector 20, in particular the spectral range in the case of fluorescence analysis, and further parameters.

If at least one of these parameters is changed by the user, the images 52 collected with the non-current parameter setting are non-current or non-matching. The display on the screen 36 can be marked accordingly, for example by means of a colouring. An exception can be in the event of a change to the image collection parameter constituted by “magnification”, if collected images of the same or greater magnification are present. If, a switch is made for example from 10× to 20×, i.e. if a switch is made from 10 times magnification to 20 times magnification, and images with 40× are already present, these images remain current and are merely shown larger.

For the selection of the scanning route 50 outside the viewing section 44, there are a number of possibilities available, from which the control unit 28 chooses one expediently depending on a future parameter. The future parameter can specify the likelihood with which the viewing section 44 will be moved to a certain location within the sample by the user. In order to determine the future parameter, the control unit 28 can perform a calculation as to where the viewing section 44 will next move, and can then control the scanning route 50 outside the viewing section 44 depending on the calculation result or the future parameter obtained thereby. Instead of or in addition to the calculation, one or more sample properties or one or more user inputs can be used.

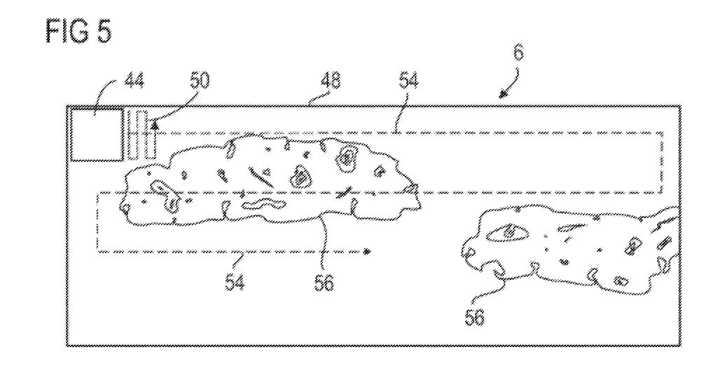

Information regarding the type of sample 6 can be inferred for example from an information field 40, 42, for example the barcode of the information field 40. The sample type for example can provide information regarding on examination method by means of which the sample 6 is to be examined. For example, a screening route 54 can be associated with the sample type, as is shown by way of example in FIG. 5.

FIG. 5 shows the sample field 48 of the sample 6 with tissue regions 56 and tissue-free regions around the tissue regions 56. If, for example, complete screening of the sample field 48 is specified, the viewing section 44, following a corresponding input of the user, automatically jumps to the start of the screening route 54, which is guided systematically, for example in a meandering manner, over the entire sample field 48. This is indicated in FIG. 5 on the basis of the meandering dashed arrow. The user moves the viewing section, for example by way of an operator means, such as a mouse, along the screening route 54. Here, the control unit 28 controls the scanning route 50 such that it runs outside the viewing section 44 along the screening route 54. If the viewing section 44 comprises just one image 52, the scanning route 50 can thus run identically to the screening route 54. If the viewing section 44 comprises a number of images 52, the scanning route 50, once the viewing section 44 has been completely covered with images 52, can run for example in a meandering manner along the screening route 54, as is indicated in FIG. 5. The scanning route 50 generally advantageously runs ahead of the movement of the viewing section 44 along the screening route 54, such that the viewing section 44 always moves into images 52 already provided. This approach can be adopted until the viewing section 44 has moved over the entire sample field 48.

In the example from FIG. 5, the screening route 54 also moves through tissue-free regions, which are not of great interest to the user. Accordingly, it is assumed that the user will guide the viewing section 44 relatively quickly through tissue-free regions. Quite generally speaking, there can be regions of interest in the sample 6, such as the tissue regions 56, and regions of no interest or less interest, such as the tissue-free regions in FIG. 5. It is advantageous if an image-collecting mode for controlling the collection of the images 52 is dependent on the course of the screening route 54 and/or the scanning route 15 through regions of different category, such as a region of interest and a region of no interest. Here, images 52 in a region of lower category are passed through more quickly than a region of higher category. The scanning route 50 can remain the same here, that is to say can be plotted independently of the region categories, if this appears to be expedient, for example in the case of a defined screening route 54. Otherwise, the scanning route 50 can also be made dependent on region categories.

Region categories can be created on the basis of image-processing methods of an image of the sample 6 collected previously, for example on the basis of an overview image. For example, tissue regions 56 are deemed to be regions of a higher category and differ from regions of lower category, for example regions containing no tissue or different tissue.

Acceleration of the collection of the images 52 can be achieved by one or more of the following measures Channels or elements of the matrix detector 20 are combined by pixel binning, such that sufficient exposure is achieved after just a relatively short exposure time. Here, the resolution of the images 52 indeed suffers, however this can be tolerated in regions of lower category. The exposure time can be reduced even without pixel binning, and the lightness of the images 52 can be increased subsequently for example by image processing, for example by increasing the image brightness, contrast and/or another measure. It is also possible to collect images during movement of the microscope lens 18, which is thus moved continuously as it is moved along its scanning route 50 and does not stop from image 52 to image 52. The image sharpness indeed suffers as a result (depending on the exposure time), however this can be tolerated in regions of lower category.

A further possibility lies in leaving out images 52 along the scanning route 50. If no region of interest or no region of higher category is present with sufficient probability in the corresponding image 52 or in the imaging field thereof, it is thus possible to dispense with the collection of the corresponding image 52. In the case of fluorescence imaging, the images 52 can be collected in just one fluorescence channel, and collection of images in other spectral channels is spared.

Quite generally, one or more of these imaging-accelerating measures can also be used if the selected resolution or image magnification of the viewing section 44 is relatively low, or more specifically: is lower than the resolution or magnification of the microscope lens 18 at least within a pre-set extent. In this case, the magnification of the microscope lens 18 is at any rate not utilised to its full extent, and therefore one or more measures compromising the image sharpness can be implemented without significant quality loss of the display of the images 52 in the desired magnification.

Generally, an acceleration measure, such as pixel binning, can be performed automatically, that is to say can be triggered automatically, without the user specifying the measure. The measure is in particular triggered depending on the zoom level of the current viewing section 44 on the screen 36. If, for example, the zoom level is lower than a limit value, the measure can be triggered automatically. User activity can also be used as a trigger parameter for an acceleration measure, such as pixel binning, for example the residence time of the viewing section 44 at a certain location.

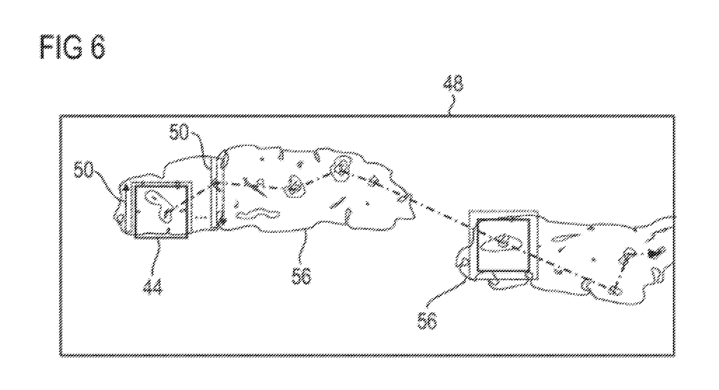

A further possibility for intelligent guidance of the scanning route 50 over the sample 6 or sample field 48 thereof is shown in FIG. 6.

FIG. 6 shows the viewing section 44 within the sample field 48 as has been selected by the user or pre-set by the control unit 28. The control unit 28 for this purpose performs a tissue identification of the sample 6 and identifies tissue regions 56, or more generally speaking: distinguishes regions of a higher category from regions of a lower category. The tissue identification can be performed on the basis of the overview image in which the tissue 56 is already imaged.

The scanning route 50 outside the current viewing section 44 is now guided in a prioritised manner within the region 56 of higher category. The scanning route 50 is for example firstly guided in a manner covering all regions of higher category, before it is guided in a region of lower category. In the example from FIG. 6, the scanning route 50 runs in a manner extending outwardly in a spiralled manner around the viewing section 44, so as to reverse the spiral direction in the next outer imaging section at region boundaries of the region 56 of higher category. This imaging section lastly leads in a meandering path over the entire tissue region 56, until this has been fully scanned. The scanning route 50 now jumps to the next tissue region 56 and scans this in a meandering manner.

If the viewing section 44 is moved by the user, it can be that it comes to lie over a region that has not yet been scanned. A scanning route 50 within the viewing section 44 depending on a movement of the viewing section 44 is now advantageous. If the user of the viewing section 44 for example moves continuously for a number of times in one direction, a meandering scanning route 50 will be selected instead of the spiralled scanning route 50 in the viewing section 44, and the direction of propagation of said meandering scanning route—analogously to the screening route 54—is selected in the direction of movement of the viewing section 44. In this way, a direction of propagation of the scanning route 50 that is inconsistent with the direction of movement of the viewing section 48 and might confuse the user is avoided.

If the tissue identification is not carried out on the basis of an overview image, it is possible to perform a random quick scan over the sample field 48, in which quick scan individual images, that is to say images 52 distanced from one another, are created. These island images 52 are now examined the tissue 56. If tissue 56 is found in an image 52, further images can now be attached to this “successful” image 52 in order to continue to image the tissue region, either immediately or once the quick scan is complete.

Alternatively or additionally to the region categories, an image type, such as a tissue type, within the current viewing section 44 can be used as further future parameter. This is likewise indicated by way of example in FIG. 6. The viewing section 44 lies not only in a tissue region 56, but covers a special type of tissue indicated in FIG. 6 by lines arranged one inside the other. The control unit 28, by means of image-processing methods, can search for identical image categories or tissue categories, for example within the overview image or another earlier collected image. Such regions are now awarded an even higher region category. The scanning route 50 now runs hierarchically through the region categories. Regions with the highest region category are scanned first. Regions with the next-highest region category are then scanned, and so on.

In the example from FIG. 6, this means that the scanning route 50 jumps from region of highest category to region of highest category, as indicated by the dot-and-dash line in FIG. 6. If the viewing section 44 is moved to another region of highest category, this is thus already imaged, such that reference can be made to stored images 52 and the viewing section can be shown at least in this region without collection of a further image 52. If the user moves the viewing section for example over another region of highest category, this is displayed immediately. The scanning route 50 now jumps from its current scanning position back into the viewing section 44 and fills this around the region of highest category. Here, regions of lower category are expediently taken into consideration, such that the scanning route 50 expediently also runs within the viewing window descending from region category to region category, that is to say—remaining by way of example in FIG. 6—first covers the tissue region 56 around the region of highest category already scanned and only once at the end covers the tissue-free region, if the viewing section also partially covers said tissue-free region.

If scanning time is available, the control unit controls the scanning route 50 such that a field having at least the size and shape of the current viewing section 44 is scanned by the region of highest category, for example with 1.5 times area size, as is shown in FIG. 6 by a dotted line around a potential future viewing section 44. If the user moves the viewing section 44 to the region of next-highest category, the entire viewing section 44 can be shown to him immediately without magnification.

A further future parameter lies in the fact that earlier movements of the viewing section 44 are taken into consideration by a user. Earlier movements can be direction-related movements or region-related movements. Direction-related movement are for example screening directions. Region-related movements are movements from one specific region to the next specific region. If, for example, the user in earlier examinations of other samples had a preference for specific regions which were found by the control unit 28 in the current sample 6, these regions can be awarded a higher category than other regions, such that the region categories can be used as future parameter.

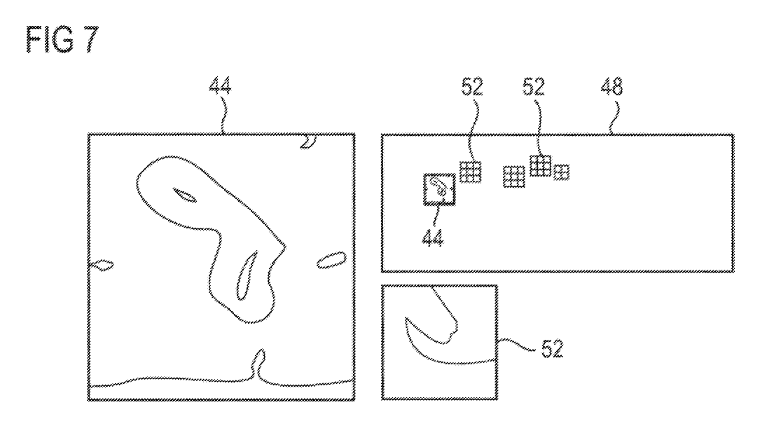

Whilst the user is inspecting the viewing section 44 or the images 52 covering the viewing section 44, the scanning route 50 outside the viewing section 44 continues to be scanned, that is to say a number of images 52 outside the viewing section 44 are collected. Instead of leaving the user unaware as to where these images 52 lie within the sample field 48, this can be shown to the user, as is illustrated in FIG. 7.

FIG. 7 shows the view of the viewing section 44 on the screen 36. The sample field 48 in the form of a rectangle is shown adjacently, in which sample field the viewing section 44 is shown in reduced size and its position within the sample field 48 is shown. The images 52 already collected are also shown in their position within the sample field 48, such that the user can identify which regions of the sample field 48 have already been scanned. He can now preferably place the viewing section 44 over such regions, such that the viewing section can be displayed wholly or partially from images 52 already collected.

In the case of automatic identification of prioritised regions, such as tissue regions 56, the images 52 are placed over such regions, such that the user is additionally provided with information as to where the prioritised regions are located. The user can hereby move the viewing section 44 even more selectively and can examine the sample 6 efficiently.

The user is thus shown the position of the collected images 52 of the scanning route 50 which lie outside the current viewing section 40. Each collected image 52 is shown as an area in accordance with its position on the sample 6 or the sample field 48.

It is likewise shown in FIG. 7 that the image 52 last collected is shown in each case, for example next to the display field of the viewing section 44. Each image 52 is covered by the subsequent image 52, such that the images 52 collected outside the viewing region 44 are displayed only briefly. This is sufficient, however, to give the user the opportunity to identify images 52 of interest. For this purpose, it is possible for the user to stop the sequence of displays of the images 52 so as to be able to look at the current image 52 for a longer period of time. Here, the scanning continues unchanged however, the only difference being that the collected images 52 are no longer shown, until the user cancels the display stop.

A potential autofocus method indeed provides an autofocus plane, however it can be that the autofocus plane is not arranged optimally with regard to the examination to be performed by the user, or that the user manually moves the focus position out of the autofocus plane for other reasons. Images 52 from the old focus plane are then non-current images 52. They are expediently labelled as such, for example coloured, and the scanning route 50 is re-defined in the current focus plane. The current focus plane expediently runs parallel to the autofocus plane.

Two possible prompts lead to the focus plane being changed. An obvious prompt is that the user changes the focus plane manually. A further prompt is the selection of a high resolution by the user which is higher than a predetermined resolution, for example from 10× or 20×. With such a high magnification, it is not unlikely that the user will later readjust the focus and thus guide it out of the autofocus plane.

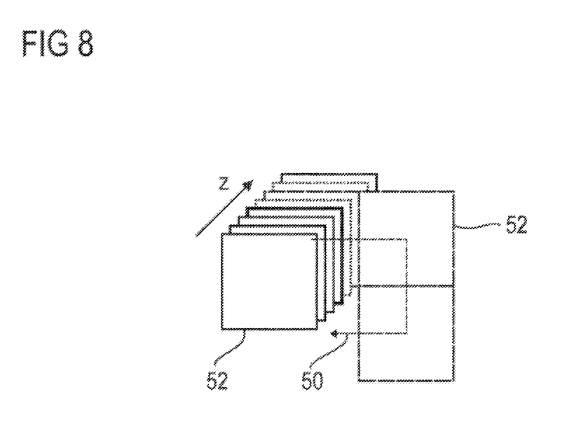

If one of these prompts is present, the scanning route 50 is guided vertically by the control unit 28. A stack of images 52 arranged one above the other is collected, said images thus lying one above the other in the x- and y-direction and being distanced from one another only in the z-direction by a predefined depth distance. The height of the stack is defined by the control unit 28 and for example is equal to a defined number of images 52 on either side of the autofocus plane. Other parameters, such as the position of the cover glass 10 or a sample support 8 can also be taken into consideration, such that the focus positions remain within the material to be analysed. This process is shown by way of example in FIG. 8.

FIG. 8 shows a stack of images 52 arranged one above the other in the z-direction, of which the image 52 with a bold outline lies in the autofocus plane. In the case of one of the above-described prompts or another prompt, the control unit 28 controls the collection of the images 52 above and below the focus plane, for example three planes above the focus plane and four planes below the focus plane, as shown in FIG. 8. All images 52 are expediently arranged centrally in the current viewing section 44. If the user attempts to adjust the focus manually, he can guide the focus through the image stack already collected previously and can search for the optimal focus plane, without having to re-create the central image 52 every time the focus is moved. This means that the focus can be adjusted very conveniently.

Only once the image stack has been completely collected is a search performed for a focus plane and the scanning route 50 traversed horizontally in this focus plane. For this purpose, the most likely focus plane selected by the user is determined. If the user for example has manually adjusted the focus downward, a focus plane lying beneath the autofocus plane is scanned. It is also possible that the control unit 28 first waits until the user has finished the adjustment of the focus and then horizontally continues the scanning route 50 in the selected plane. This is shown in FIG. 8 by the dashed images 58. The scanning route 50 runs outwardly in a spiralled manner, widening around the central image 52, as described in relation to FIG. 3. Images 52 of the non-current focus plane can remain displayed here, but are expediently marked as non-current, as described in the example from FIG. 4.

If the scan in the viewing section 44 in the selected focus plane is complete, for example the dashed plane from FIG. 8, it can be continued in an adjacent focus plane, such that the scanning route 50 thus jumps to an adjacent focus plane. The adjacent focus planes are indicated by dots in FIG. 8. If the focus is re-adjusted by the user, images already collected can be referred to directly, and the viewing section 44 can be displayed immediately.

If the scanning route 50 leaves the current image plane, for example in order to collect one or more images 52 in an adjacent focus plane, the scanning route in the sense of the invention is thus guided out of the viewing section 44, since the current viewing section 44 is a two-dimensional viewing section 44 in the current image plane. Each image plane change of the scanning route 50, that is to say focus plane change, spectral change and/or exposure change, etc. from the current image plane of the viewing section 44 leads the scanning route 50 in the sense of the invention out of the current viewing section 44, even if the scanning route 50 should still remain in the x-y region of the viewing section 44.

The completion of the scan in a focus plane does not have to be based on the entire sample field 48. It is sufficient if the viewing section 44 is fully scanned, such that a jump is then made to the adjacent focus plane and the viewing section 44 continues to be scanned in this plane. Instead of the viewing section 44, regions of the highest category can also be scanned first, wherein a jump is then made to another focus plane when all regions of highest category have been scanned.

For the case in which the user has selected a high magnification and consequently the image stack as presented by way of example in FIG. 8 has been created, but the user has not actually moved the focus plane out of the autofocus plane within a predefined time, a scanning process or the scanning route 50 in a plane outside the focus plane can thus be terminated, and the scanning process can be continued in the autofocus plane. Generally, the autofocus plane is preferred over other planes when selecting the scanning route 50 if it is unclear whether the user will change the focus plane.

In the case of a fluorescence analysis of the sample 6, the following parameters can be taken into consideration or changed, wherein—where applicable apart from the changes due to the fluorescence analysis—reference can be made fully to the above method steps from the bright field method.

In the case of fluorescence analysis, a number of spectral channels can be used, such that the sample 6 is illuminated with different spectra. To this end, the digital microscope 2 contains one or more spectral filters 58, which can be introduced into the beam path 60 and can limit the radiation to the desired spectrum. The beam path of the illumination or excitation, the source of which is not shown in FIG. 1 for the sake of clarity, is provided here expediently at least between the microscope lens 18 and sample 6 in the imaging beam path 60. A beam path which is coupled into the imaging beam path via a semi-transparent mirror, possibly also before the microscope lens, is expedient. The one or more spectral filters 58 is/are advantageously introduced into the illumination beam path 60 before the sample 6, such that the sample 6 is illuminated as gently as possible.

Each spectral channel can be considered to be an image plane, similarly to the focus planes, such that the number of possible image planes is given by multiplying the number of spectral channels by the number of focus planes.

In the case of fluorescence analysis an overview image is also expediently created in the transmissive light and/or bright field in order to give the user a first overview of the sample 6. Alternatively or additionally, an overview image can be created in the fluorescence spectrum, wherein the scanning process is expediently initially limited to one spectral channel, in particular the channel of the most stable colouring, for example the most stable DAPI colouring. The scanning route 50 can be selected both horizontally and vertically, similarly to the bright field method.

The viewing section 44 can then be selected by the user, as described with reference to the bright field method, wherein the magnification can be pre-set, for example to 10×. In the case of fluorescence analysis, a manual focus adjustment is then presumably performed by the user, such that the image stack is firstly created in the z-direction, preferably in a number of fluorescence channels, in particular in all fluorescence channels. The user can set an exposure time, in particular for all fluorescence channels, wherein the exposure time can be displayed in the viewing section 44 for easier orientation, for example below the central image 52 in the viewing section 44.

The advance scanning can now be performed, for example as described above, wherein the region categories can be used also with a plurality of fluorescence channels. In addition, the fluorescence channels can be categorised. Starting from the channel of highest category, for example the current fluorescence channel, all fluorescence channels can be scanned, category region by category region, wherein the scanning route 50 thus changes the region or the category region when the region in all fluorescence channels has been traversed. If manual refocusing is performed, the scanning route 50 first pivots on the vertical z-direction and collects the image stacks in all fluorescence channels, before the horizontal scan is resumed in a desired focus plane.

Since in the fluorescence mode a region categorisation is in some circumstances more difficult than in the bright field mode, it can be expedient to perform the advance scanning with use of a parameter for acceleration of the scanning speed, for example a shorter exposure time with or without pixel binning and/or the omission of images in the course of the scanning route 50. Here, the advance scanning can be performed in all fluorescence channels, in each case with use of at least one acceleration parameter. The user can in this way look over the sample 6 relatively quickly and find the region of most interest for him, for example a region with particularly good colouring. The use of an acceleration parameter, however, should be implemented only with magnification below a limit magnification, for example only up to 10×. If the user sets the magnification higher, for example 20×, the continuous scanning is performed without acceleration parameter in order to provide the optimal image quality.

Parameter changes which make it expedient to change the scanning route 50 can occur quite independently of parameter changes made wilfully by a user. For example, if the digital microscope is shaken, there is a significant risk that the images recorded during the shaking will be “wibbly” and blurred. The vibration is recorded by the control unit 28, which is connected to an acceleration sensor 62. In the event of an acceleration above a limit value, the period of time of this strong acceleration is measured, and all images collected within this period of time are repeated. The scanning route 50 is thus interrupted and resumed at an earlier route point.

Temperature fluctuations in the region around the microscope lens 18 are also detected by the control unit 28 with the aid of a temperature sensor. If a temperature fluctuation rises above a predefined threshold value, this thus triggers an inspection of the autofocus. The threshold value can be based here on the temperature at which the autofocus was last performed. If, for example, in winter a window is opened in a laboratory in which the digital microscope 2 is set up and said digital microscope consequently cools very quickly or if sunlight is suddenly directly incident on the digital microscope 2 due to the movement of the sun, such that said digital microscope suddenly heats up significantly, a critical temperature change can occur readily.

The autofocus process can have the result that a new autofocus plane is selected, such that the depth of the focus in the sample is changed. This is also a change to an image collection parameter and leads to a change of the image plane of the collected images, such that the scanning route 50 is recalculated, terminated and resumed.

Regardless of shaking and temperature, it is expedient to check the autofocus at predefined time intervals. If this examination reveals a change to the autofocus, this thus also leads to a change to the image plane of the collected images, such that the scanning route 50 is recalculated, terminated and resumed.

During a scan it is often the case that the user does not make any inputs, whether this is because he is intently studying a viewing section 44 or whether he is performing another task. If an input-free time lasts longer than a limit value, this leads to a change of the scanning mode, which can likewise cause the scanning route 50 to be recalculated, terminated and resumed. In the new scanning mode a low creation of noise is awarded a higher weighting and quick scanning is awarded a lower weighting. Consequently, the scanning route 50 will have more straight sections and fewer changes in direction, since a change in direction of the microscope lens 18 from one image 52 to the next causes more noise than a straight-line sequence of images 52. The scanning speed can also be reduced, wherein this can be achieved by a slower acceleration of the microscope lens 18 from one collected image to the next.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. Accordingly, the exemplary implementations set forth above, are intended to be illustrative, not limiting.

What is claimed is:

1. A method for digitally collecting an image of a sample (6) by a microscope (16), comprising:
selecting a viewing section (44) of the sample (6);
moving a microscope lens (18) is moved in a scanning route (50) over this viewing section (44),
digitally collecting and displaying first a sequence of mutually offset images (52) covering the viewing section (44); and
subsequently continuing the scanning route (50) with a sequence of images (52) outside the selected viewing section (44).

2. The method according to claim 1, wherein the scanning route (50) is guided within the viewing section (44) outwardly from the centre of the viewing section (44).

3. The method according to claim 1, wherein the scanning route (50) is continued outside the viewing section (44) in a manner extending outwardly in a spiral manner around the viewing section (44).

4. The method according to claim 1, wherein once the viewing section (44) has been moved, any regions present that have already been imaged are displayed and those regions of the viewing section (44) that have not yet been imaged are collected first by the microscope lens (18).

5. The method according to claim 1, wherein in order to display the sample (6) in the viewing section (44), reference is made first to one or more non-current collected images with current microscope settings, which non-current collected images are covered image (52) by image (52) by the current sequence.

6. The method according to claim 5, wherein the display of the non-current collected image is distinguished from the display of a current image in such a way that a distinction between the non-current collected image and a current image (52) is made possible.

7. The method according to claim 5, wherein the non-current collected image is at least part of an overall collected image of the sample (6).

8. The method according to claim 5, wherein the non-current collected image was collected in a different spectral range compared to the sequence of the images (52).

9. The method according to claim 5, wherein
the non-current collected image was collected with a different focus position in the sample (6).

10. The method to claim 1, wherein pixel binning of a detector (20) collecting the images (52) is performed depending on the size of the viewing section (44).

11. The method according to claim 1, wherein an exposure time of the images (52) is selected depending on the size of the viewing section (40).

12. The method according to claim 1, wherein a spectral channel selection of the images (52) is performed depending on the size of the viewing section (44).

13. A digital microscope (2), comprising:
a sample holder (4);
a microscope lens (18);
a drive (12, 26) for moving the microscope lens (18) relative to the sample (6);
a camera (22) for collecting an image of the sample (6) through the microscope lens (18);
a control unit (28) for controlling the drive (12, 26) and the holder; and
a display means (36) for displaying the collected image, wherein the control unit (28) is programmed to move the microscope lens (18) in a scanning route (50) over a viewing section (44), to digitally collect a sequence of mutually offset images (52) covering the viewing section (44), and to subsequently continue the scanning route (50) with a sequence of images (52) outside the current viewing section (44).
